(19) United States
(12) Patent Application Publication
(10) Pub. No.: US 2025/0111255 A1
(43) Pub. Date: Apr. 3, 2025

(54) SYSTEM AND METHOD FOR REMOVAL OF STATISTICAL BIAS IN PREDICTIVE MODELS ARISING FROM MISSING VALUES IN TRAINING DATA

(71) Applicant: JPMorgan Chase Bank, N.A., New York, NY (US)

(72) Inventors: Alan MISHLER, Pittsburgh, PA (US); Mohsen GHASSEMI, Jersey City, NJ (US); Alec KOPPEL, New York, NY (US); Sumitra GANESH, Short Hills, NJ (US)

(73) Assignee: JPMorgan Chase Bank, N.A., New York, NY (US)

(21) Appl. No.: 18/375,182

(22) Filed: Sep. 29, 2023

(51) Int. Cl. G06N 7/01; G06N 20/00

(52) U.S. Cl. CPC G06N 7/01; G06N 20/00

(57) ABSTRACT

A method and system for accounting for missing not-at-random (MNAR) data in training dataset via Bayesian regularization are disclosed. The method includes acquiring historical data of an organization, the historical data including the MNAR data. The method further includes performing estimation for two of at least three unknown quantities based on the historical data, and injecting quantitative information for remaining one of the at least three unknown quantities based on qualitative information regarding nature of missingness. Lastly, the method reassembles the estimation for two of the at least three unknown quantities and injected quantitative information for the remaining one of the at least three unknown quantities, to provide a modified function.

### TECHNICAL FIELD

This disclosure generally relates to data processing. More specifically, the present disclosure generally relates to accounting for datasets with missing not-at-random (MNAR) outcomes by removing statistical bias in predictive models that are trained using those datasets via Bayesian regularization.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Conventionally, training data is often used to develop predictive models, which map a set of input features to an output that may represent an estimated label or numerical quantity. For example, a predictive model may be trained to estimate a price at which a person is willing to transact, using features such as the person's transaction history and current market conditions. Often, outcomes, such as a label or numerical quantity that the model will be trained to predict, are selectively missing in the training data. For example, when a potential customer ends up transacting with a competitor different from a target organization, the target organization may be unaware of the attributes involving the transaction conducted with the competitor, including the price at which they ultimately transact. When the missing outcome values are residually correlated with the missingness indicator conditional on the features, then the outcomes are said to be missing not-at-random (MNAR). Datasets with MNAR outcomes may induce bias in predictive models that are trained on such data. In other words, these predictive models may have systematic errors in their outputs that are unrelated to the size of the training data. Accordingly, no matter how much training data may be collected, the respective bias may remain in models that are trained using the training data.

### SUMMARY

According to an aspect of the present disclosure, a method for accounting for missing not-at-random (MNAR) data in training datasets via Bayesian regularization is provided. The method includes acquiring, by a processor and from at least one database, historical data of an organization, the historical data including the MNAR data, the MNAR data being data where outcomes are MNAR: generating, by the processor, a function based on the acquired historical data: decomposing, by the processor, the function into a plurality of separate components, the plurality of separate components including at least three unknown quantities: performing, by the processor, estimation for two of the at least three unknown quantities, the estimation includes training machine learning models for the two unknown quantities: injecting, by the processor, quantitative information for remaining one of the at least three unknown quantities based on qualitative information regarding the nature of the missingness; and reassembling, by the processor, the estimation for two of the at least three unknown quantities and injected quantitative information for the remaining one of the at least three unknown quantities, to provide a modified function.

According to another aspect of the present disclosure, a Bayes risk minimizer is utilized in the performing of the estimation.

According to yet another aspect of the present disclosure, wherein the risk function that the Bayes risk minimizer seeks to minimize is the mean squared error (MSE).

According to another aspect of the present disclosure, the Bayesian regularization utilizes external information about the function when the missingness indicator is 0 to construct the modified function.

According to a further aspect of the present disclosure, the risk function that the Bayes risk minimizer seeks to minimize is 0-1 loss.

According to yet another aspect of the present disclosure, a value within a reference vicinity of one of the two unknown quantities being estimated when a missingness indicator is 0 is utilized to construct the modified function.

According to a further aspect of the present disclosure, the MNAR property in the training data is ad dressed without using an assumption or a restriction about the distribution of the missing values.

According to another aspect of the present disclosure, one of the estimated functions is constructed by regressing an outcome on features in the labeled data.

According to a further aspect of the present disclosure, the other of the estimated functions is constructed by regressing a missingness indicator on the features in both the labeled data and unlabeled data.

According to a further aspect of the present disclosure, the estimation of the two of the at least three unknown quantities is performed by training two separate machine learning models.

According to a further aspect of the present disclosure, a first of the two machine learning models is trained based on both labeled data and unlabeled data, and a second of the two machine learning models is trained only on the labeled data.

According to a further aspect of the present disclosure, a regression function that relates missing outcomes to features is unknown.

According to a further aspect of the present disclosure, the reassembling incorporates priors over the MNAR outcomes.

According to a further aspect of the present disclosure, the reassembling is performed using a linear combination.

According to a further aspect of the present disclosure, the injecting of the quantitative information includes injecting the qualitative information in a form of a prior over E[m₀(x)] at each point x.

According to a further aspect of the present disclosure, the quantitative information for the remaining one of the at least three unknown quantities is injected by a domain expert.

According to an aspect of the present disclosure, a system for accounting for MNAR data in training dataset via Bayesian regularization is provided. The system includes a memory, a display and a processor. The system is configured to perform: acquiring, from at least one database, historical data of an organization, the historical data including the MNAR data, the MNAR data being data where outcomes are MNAR; performing estimation for two of the at least three unknown quantities based on the historical data, the estimation includes training machine learning models for the two unknown quantities; injecting quantitative information for the remaining one of the at least three unknown quantities based on qualitative information regarding a nature of missingness; and reassembling the estimation for two of the at least three unknown quantities and injected quantitative information for the remaining one of the at least three unknown quantities, to provide a modified function.

According to another aspect of the present disclosure, a non-transitory computer readable storage medium that stores a computer program for accounting for MNAR data in training dataset via Bayesian regularization is provided. The computer program, when executed by a processor, causes a system to perform multiple processes including: acquiring from at least one database, historical data of an organization, the historical data including the MNAR data, the MNAR data being data where outcomes are MNAR; performing estimation for two of the at least three unknown quantities based on the historical data, the estimation includes training machine learning models for the two unknown quantities; injecting quantitative information for the remaining one of the at least three unknown quantities based on qualitative information regarding a nature of missingness; and reassembling the estimation for two of the at least three unknown quantities and injected quantitative information for the remaining one of the at least three unknown quantities, to provide a modified function.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a bias reduction in missingness-not-at-random outcome (BRIMNAR) system in accordance with an exemplary embodiment.

FIG. 2 illustrates an exemplary diagram of a network environment with a BRIMNAR system in accordance with an exemplary embodiment.

FIG. 3 illustrates a system diagram for implementing a BRIMNAR system in accordance with an exemplary embodiment.

FIG. 4 illustrates a method for accounting for statistical bias caused by presence of MNAR in training dataset by performing Bayesian regularization in accordance with an exemplary embodiment.

FIGS. 5A-5C illustrate classification error for two binary classification tasks with induced MNAR from a benchmark dataset in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

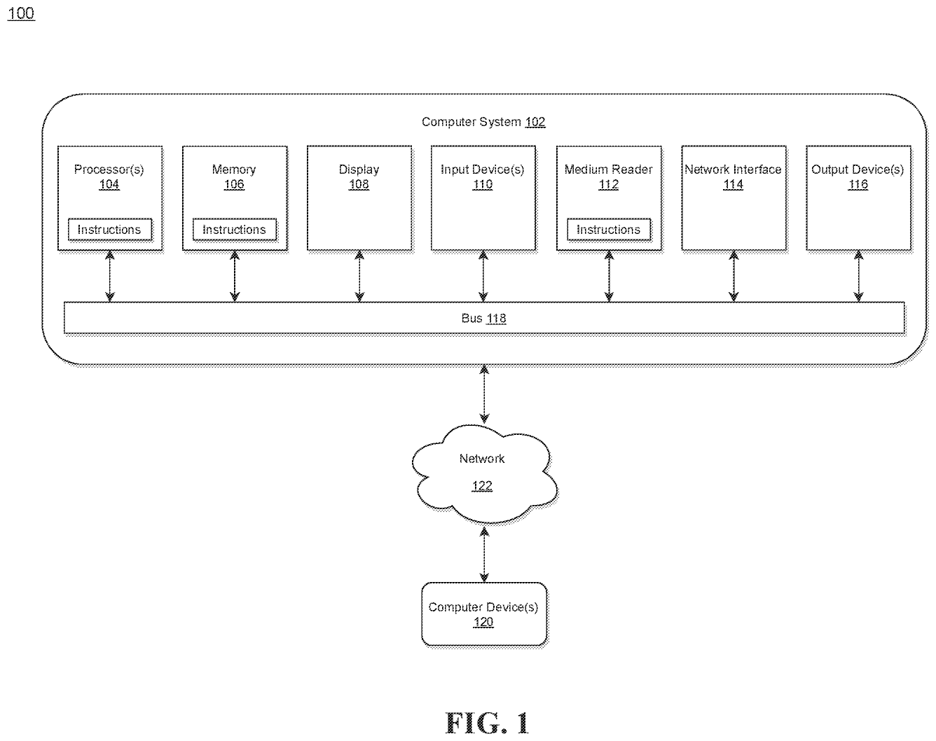

FIG. 1 illustrates a computer system for implementing a bias reduction in missingness-not-at-random outcome (BRIMNAR) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a key board, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

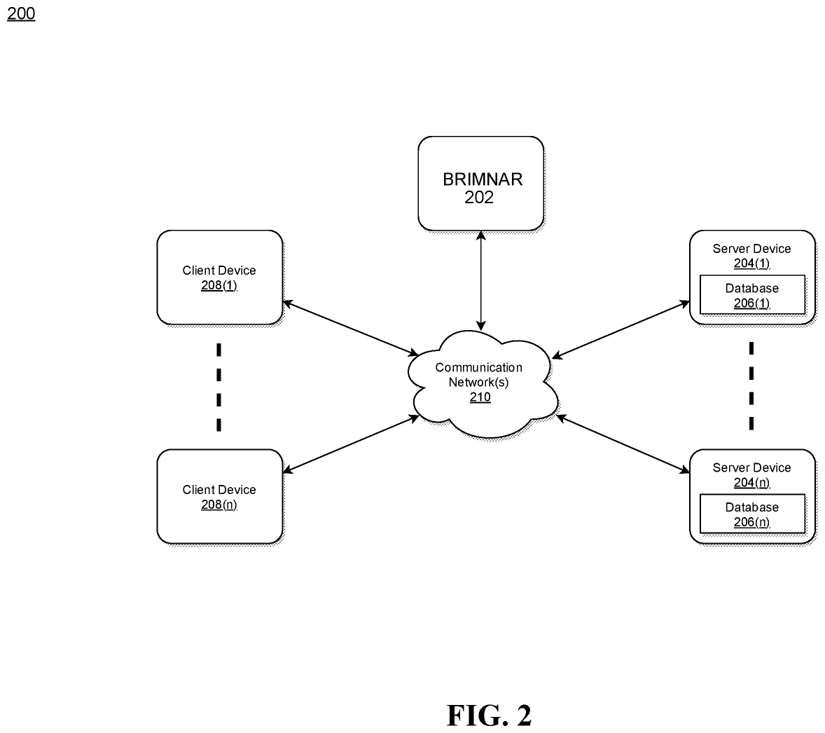

FIG. 2 illustrates an exemplary diagram of a network environment with a BRIMNAR system in accordance with an exemplary embodiment.

A BRIMNAR system 202 may be implemented with one or more computer systems similar to the computer system 102 as described with respect to FIG. 1.

The BRIMNAR system 202 may store one or more applications that can include executable instructions that, when executed by the BRIMNAR system 202, cause the BRIMNAR system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the BRIMNAR system 202 itself, may be located in virtual server(s) running in a cloud-based computing environment rather than being tied to one or more specific physical network computing devices. Also, the application(s) may be running in one or more virtual machines (VMs) executing on the BRIMNAR system 202. Additionally, in one or more embodiments of this technology, virtual machine(s) running on the BRIMNAR system 202 may be managed or supervised by a hypervisor.

In the network environment 200 of FIG. 2, the BRIMNAR system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the BRIMNAR system 202, such as the network interface 114 of the computer system 102 of FIG. 1, operatively couples and communicates between the BRIMNAR system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the BRIMNAR system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The BRIMNAR system 202 may be a standalone device or integrated with one or more other devices or apparatuses, such as one or more of the server devices 204(1)-204(n), for example. In one particular example, the BRIMNAR system 202 may be hosted by one of the server devices 204(1)-204(n), and other arrangements are also possible. Moreover, one or more of the devices of the BRIMNAR system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the BRIMNAR system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the BRIMNAR system 202 that may efficiently provide a platform for implementing a cloud native BRIMNAR system module, but the disclosure is not limited thereto.

The client devices 208(1)-208(n) may run interface applications, such as standard web browsers or standalone client applications, which may provide an interface to communicate with the BRIMNAR system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the BRIMNAR system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the BRIMNAR system 202, the server devices 204(1)-204(n), or the client devices 208(1)-208(n), for example, may be configured to operate as virtual instances on the same physical machine. For example, one or more of the BRIMNAR system 202, the server devices 204(1)-204(n), or the client devices 208(1)-208(n) may operate on the same physical device rather than as separate devices communicating through communication network(s) 210. Additionally, there may be more or fewer BRIMNAR system 202, server devices 204(1)-204(n), or client devices 208(1)-208(n) than illustrated in FIG. 2. According to exemplary embodiments, the BRIMNAR system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

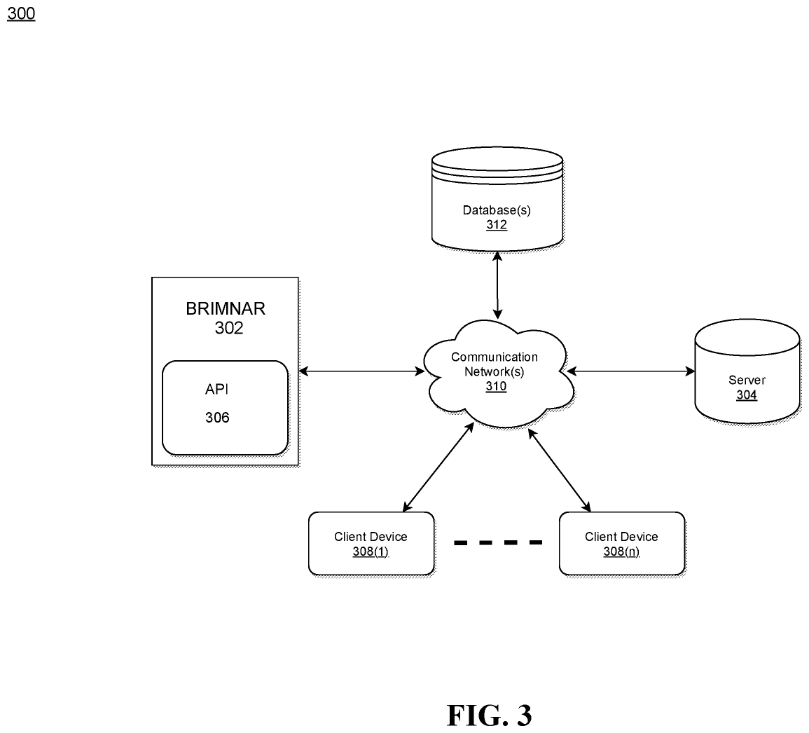

FIG. 3 illustrates a system diagram for implementing a BRIMNAR system in accordance with an exemplary embodiment.

As illustrated in FIG. 3, the system 300 may include a BRIMNAR system 302 within which a group of API modules 306 is embedded, a server 304, a database(s) 312, a plurality of client devices 308(1) . . . 308(n), and a communication network 310.

According to exemplary embodiments, the BRIMNAR system 302 including the API modules 306 may be connected to the server 304, and the database(s) 312 via the communication network 310. Although there is only one database that has been illustrated, the disclosure is not limited thereto. Any number of databases may be utilized. The BRIMNAR system 302 may also be connected to the plurality of client devices 308(1) . . . 308(n) via the communication network 310, but the disclosure is not limited thereto.

According to exemplary embodiment, the BRIMNAR system 302 is described and shown in FIG. 3 as including the API modules 306, although it may include other rules, policies, modules, databases, or applications, for example. According to exemplary embodiments, the database(s) 312 may be embedded within the BRIMNAR system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable BRIMNAR system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the BRIMNAR system 302. In this regard, the plurality of client devices 308(1) . . . 308(n) may be “clients” of the BRIMNAR system 302 and are described herein as such. Nevertheless, it is to be known and understood that the plurality of client devices 308(1) . . . 308(n) need not necessarily be “clients” of the BRIMNAR system 302, or any entity described in association therewith herein. Any additional or alternative relationship may exist between either or both of the plurality of client devices 308(1) . . . 308(n) and the BRIMNAR system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the BRIMNAR system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The BRIMNAR system 302 may be the same or similar to the BRIMNAR system 202 as described with respect to FIG. 2, including any features or combination of features described with respect thereto.

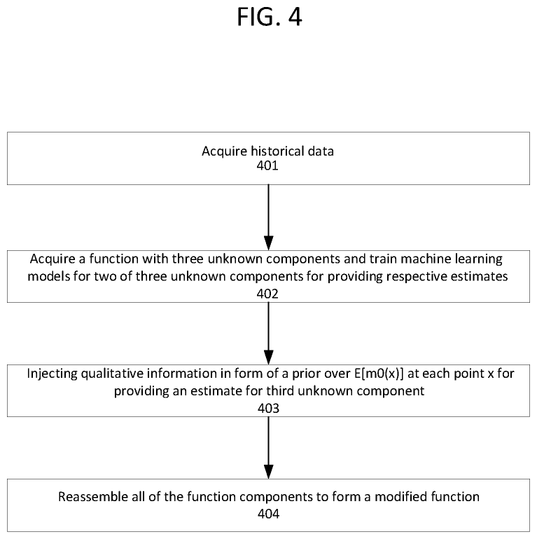

FIG. 4 illustrates a method for accounting for statistical bias caused by presence of MNAR in training dataset by performing Bayesian regularization in accordance with an exemplary embodiment.

MNAR is regarded as a difficult problem to address, and many existing methods attempt to address the issue by assuming it away or by placing strong assumptions on the data generating process in order to arrive at a tractable method for addressing it. However, such approaches can lead poorly performing predictive models when the assumptions that they rely on are a poor description of the actual data generating process. In contrast to the existing methods, exemplary methods provided in the present application place virtually no assumptions on the data generating process to allow for applicability in wide range of settings.

According to exemplary aspects, a method by which qualitative external information may be quantitatively incorporated into a model training process is provided. More specifically, a nonparametric model of the missingness, a nonparametric model of an observable outcome and a Bayesian prior or probability distribution over conditional means of the missing outcomes are combined. Further, a posterior is derived based on such combination. This method may be understood from two perspectives. First, it allows domain experts to incorporate problem-specific knowledge to regularize the predictive model in order to reduce bias cause by the presence of MNAR in the training data. Second, it allows users to systematically investigate how sensitive a downstream predictive model is to different degrees of severity of MNAR. Accordingly, users without domain expertise may determine whether MNAR may be safely ignored in their problem or whether it may induce noticeable or nontrivial bias, such that the users may decide what other steps to take to address it.

More specifically, prediction models may encounter a problem when data exhibit missing values that are residually correlated with the missingness, i.e., the MNAR setting. Datasets with MNAR outcomes may induce arbitrary levels of bias in downstream prediction tasks. According to exemplary aspects, in order to counteract such bias, one may incorporate additional information that is external to the data. More specifically, external information may be incorporated into predictive models in the form of Bayesian priors. When the priors represent substantive knowledge about the problem, performance improvement over models with discarded missing values is observed. Here, even naive values may sometimes result in improvements as well, presumably when the baseline predictor has overfit the training data.

In operation 401, historical data for training a machine learning (ML) or artificial intelligence (AI) model is acquired via a network from one or more sources within an organization. In an example, historical data may include basic information of an individual or entity, such as name, address, date of inquiry, purpose of inquiry, and the like. The acquired historical data may also indicate data corresponding to a transaction conducted with the respective organization. However, the historical data may also include basic information of an individual or entity but without any information corresponding to a transaction despite having the basic information. In such an instance, it may be inferred that the respective individual or entity did not follow through with the transaction after initial inquiry. More specifically, such individual or entity may have decided against transacting after further consideration or decided to conduct the transaction with a competing organization. In such a case, the missing transaction information may be determined to be MNAR data, which may be unable to be accounted for conventionally in training the ML or AI model.

When missingness is conditionally independent of the actual missing values, then unbiased and consistent estimators of many quantities of interest may be obtained using the observable data. In many cases, however, the missingness may be systematically related to the missing values. For example, in a survey research, respondents with more negative outlooks may be more likely to decline to respond. Similarly, in clinical trials, an unmeasured demographic attribute may influence patients' likelihood of dropping out of the trial as well as their treatment response. In such scenarios, the target outcome (e.g., attitude towards a survey topic, treatment response) is referred to as MNAR. MNAR datasets may induce arbitrarily large bias in downstream estimators. Accordingly, in order to obtain accurate and/or reliable downstream results, bias induced by the MNAR datasets has to be adequately remediated.

Unlike the conventional approach of investigating how a predictive model would vary in response to different degrees of MNAR severity, aspects of the present disclosure consider how a predictive model may be made robust to different degrees of MNAR. Accordingly, even in the presence of MNAR datasets, aspects of the present disclosure may be able to provide a workable predictive model, rather than merely identifying an impact by a degree of MNAR severity as proffered by conventional practice. In an example, such a predictive model that may be robust to differing degrees of MNAR may be provided by a Bayesian approach. According to further aspects, the Bayesian approach may incorporate priors over the missing portion of the data generating process, instead of simply ignoring the missing portion. Such an approach may improve accuracy and reliability in the MNAR setting, relative to a baseline which discards rows with missing outcomes.

A function (e.g., m(x)) or an AI/ML model is generated based on the acquired data. In an example, the generated function or ML/AI model may be regarded as estimates of unknown functions. According to exemplary aspects, the generated function may be based on both labeled and unlabeled data, and may include various unknown quantities corresponding to the MNAR data.

According to exemplary aspects, a distribution P over features X∈X⊂R^{p}, outcomes or labels Y∈y, and a missingness indicator D∈{0,1} may be provided. y may refer to a subset of R in the case of regression or {0,1} in the case of binary classification. Independent and identically distributed samples {(Xᵢ, Dᵢ, DᵢYᵢ}ᵢ₌₁^{a} from P may be provided, where DiYi denotes the scalar product between D and Y. This construction indicates that Y is only observed when D=1 and is otherwise set to 0. According to further aspects, the historical data may be partitioned into a labeled set L={(Xi, Di, DiYi):Di=1} and an unlabeled set U={(Xi, Di, DiYi):Di=0}.

In operation 402, a function with three unknown components is acquired. The function may include separate components or parts. The separate components or parts may include unknown quantities corresponding to MNAR. According to exemplary aspects, the following key quantities are defined:

$$m ( x ) = E [ Y \vert X = x ]$$

$${m}_{d} ( x ) = E [ Y \vert X = x , D = d ] , for d ∈ \{ 0 , 1 \}$$

$$π ( x ) = P ( D = 1 \vert X = x )$$

With respect to the above noted quantities, the expected outcome Y is conditional on features X, the expected outcome Y is conditional on features X and missingness indicator D, and the probability that the missingness indicator D is 1 is conditional on features X, which may be referred to as the missingness propensity.

According to exemplary aspects, a primary goal of the disclosed method may be to construct a model to predict Y from X so as to minimize either mean squared error (MSE) (for regression) or 0-1 error (for classification). In other words, estimation of function m(x) is sought to be as accurate as possible while accommodating the MNAR. A challenge arises from the fact that an estimate for m₀(x) may be unable to be estimated from data, since Y is never observed when D=0. More specifically, since P(Y|X, D=0) is not observable, itis impossible to tell from the data whether the outcomes Y are completely at random (MCAR), missing at random (MAR) or MNAR. An assumption that the missingness belongs to of these categories cannot be tested with data. Accordingly, potential bias due to MNAR may be addressed by injecting external information. This process around the following key expansion of m(x):

$$m ( x ) = {m}_{1} ( x ) π ( x ) + {m}_{0} ( x ) ( 1 - π ( x ) )$$

In the MNAR setting, an estimate \hat{m}₁(x) may be constructed by regressing Y on X in the labeled data L, while an estimate \hat{π}(x) may be constructed by regressing D on X in the labeled and unlabeled data L∪U. Using external information about m₀(x), an estimate \hat{π}(x) may be constructed via Bayesian regularization.

Further in operation 402, estimations for two of the three unknown quantities or components are performed based on the historical data. More specifically, the estimations of the two of the three unknown quantities may be performed by training two separate machine learning models.

According to exemplary aspects, consider the following uncertainty set P={Q(X,D,Y):Q(X,D,DY)=P(X,D,DY)} representing all possible distributions that could give rise to the observable distribution P(X, D, DY). With respect to such uncertainty set, suppose a prior S over P is provided. In such an example, within a chosen function class F, the Bayes risk minimizer f* may be sought. The Bayes risk minimizer f* may be defined as provided below:

$${f}^{*} = {argmin}_{f ϵ ℱ} \{ {𝔼}_{S} [ {𝔼}_{Q} [ ℓ ( f ( X ) , Y ) ] ] \}$$

According to exemplary aspects, the above noted approach represents a novel way of making the resulting predictor robust to MNAR-related uncertainties.

Since the only unknown part of P(X, D, Y) that may be relevant to m(x) is the conditional expectation of m₀(x), a simple way to arrive at a tractable version of the Bayes risk minimizer f* is to define a prior over m₀(x) instead of placing priors over each element of P. In particular, it may be convenient to place independent priors on values of m₀(x) at each x. Such practice may induce a prior over each value of m(x).

Two propositions are disclosed for inducing the prior over each value of m(x), the first being a Bayes solution with respect to mean squared error (MSE) and the second being a Bayes solution with respect to 0-1 loss. In this regard, the Bayes risk minimizer f* for MSE and 0-1 loss simply require the mean of the prior at each x. Since m₁(x) and π(x) may be estimated from the data, these quantities are treated as being fixed. However, aspects of the present disclosure are not limited thereto, such that m₁(x) and π(x) may be extended to a fully Bayesian setting which involves placing priors on these components.

More specifically, with respect to the first proposition or Bayes solution (with respect to, MSE), the following relationship is assumed: l(f(X), Y)=(f(X)−Y)², in which F is set of all functions f: X→Y, and the prior S over the function m₀(x) is the product of independent priors over the value M₀(x) at each x. For this proposition, the Bayes risk minimizer is defined by:

$${f}^{*} ( x ) = π ( x ) {m}_{1} ( x ) + ( 1 - π ( x ) ) 𝔼 [ {m}_{0} ( x ) ]$$

In this proposition, when the loss is MSE, the Bayes risk minimizer is the mean of the posterior distribution.

Since P(X) is fixed with respect to the prior S, it suffices to minimize the expected error at each point x. The minimizer of Bayes risk corresponds to the mean of the posterior distribution. In this case, since m₁(x), π(x) are fixed, and since there is no data to update the prior over m₀(x), the minimizer at any given x is:

$$𝔼 [ m ( x ) ] = {m}_{1} ( x ) π ( x ) + 𝔼 [ {m}_{0} ( x ) ] ( 1 - π ( x ) )$$

As referenced earlier, this may be made fully Bayesian by placing prior over m₁(x) and π(x) as well. These priors may be updated using the observed data to obtain an overall posterior for m(x).

With respect to the second proposition or Bayes solution, the following relationship is assumed: l(f(X), Y)=1 {Y≠f(X)}, where 1{·} is the indicator function, in which F is set of all functions f: X→ {0,1}, and the prior S over the function m₀(x) is the product of independent priors over the value m₀(x) at each x. For this proposition, the Bayes risk minimizer is defined by:

$${f}^{*} ( x ) = \{ π ( x ) = {m}_{1} ( x ) + ( 1 - π ( x ) ) 𝔼 [ {m}_{0} ( x ) ] \geq 0.5 \}$$

Further, with respect to the second proposition, fix a point x, consider an arbitrary f(x)∈R, and assume a prior exists over m(x). In this scenario, the 0-1 loss is as provided below:

$$ℙ ( Y \neq f ( x ) ) = f ( x ) ℙ ( Y \neq 1 \vert X = x ) + ( 1 - f ( x ) ) ℙ ( Y \neq 0 \vert X = x ) = f ( x ) ( 1 - m ( x ) ) + ( 1 - f ( x ) ) m ( x )$$

Taking the expectation over m(x), the following relationship is provided:

$$f ( x ) ( 1 - 𝔼 [ m ( x ) ] ) + ( 1 - f ( x ) ) 𝔼 [ m ( x ) ]$$

whose minimizer f* is:

$${f}^{*} ( x ) = \{ 𝔼 [ m ( x ) ] \geq 0.5 \} = \{ π ( x ) 𝔼 [ {m}_{1} ( x ) ] + ( 1 - π ( x ) ) 𝔼 [ {m}_{1} ( x ) ] \geq 0.5 \}$$

In other words, the Bayes estimator just thresholds the regularized regression function.

According to exemplary aspects, the functions defined for the first proposition and the second proposition may be estimated by constructing estimates \hat{m}₁(x), \hat{π}(x) as described above. Since only the quantity E[m₀(x)] is required at each x, it is not actually necessary to specify a whole prior at each x, only a single value that represents a reasonable estimate at the value of m₀(x). According to exemplary aspects, what constitutes a reasonable estimate depends on the data generating process. However, there is potentially a wide range of values within a reference vicinity of m₀(x) that may yield improvements over a baseline approach that simply ignores m₀(x). Such reasonable estimates may be derived from domain knowledge, or they may be treated as sensitivity parameters.

Previous approaches for addressing the MNAR setting utilize specific models for the missing data distribution, or they impose additional assumptions that allow such distribution to be identified (e.g., monotonicity assumptions or parametric assumptions). In contrast, exemplary aspects of the present disclosure utilize a very generic setting without utilizing any of these assumptions or restrictions.

In operation 403, qualitative information may be injected in a quantitative manner into another component of the decomposed function for obtaining an estimate when missingness indicator is 0. In an example, qualitative information may be injected in a quantitative manner by a domain expert, who may have qualitative information to inject quantitative information to account for the MNAR. For example, when a customer applies for a loan with Banks 1 and 2 and ultimately chooses Bank 2, Bank 1 does not observe the APR that the customer received. Accordingly, Bank 1 may have identification information of the respective customer but not the APR information, and thus, the customer's APR information may be MNAR. In such a scenario, a domain expert may be able to inject quantitative information, such as APR values.

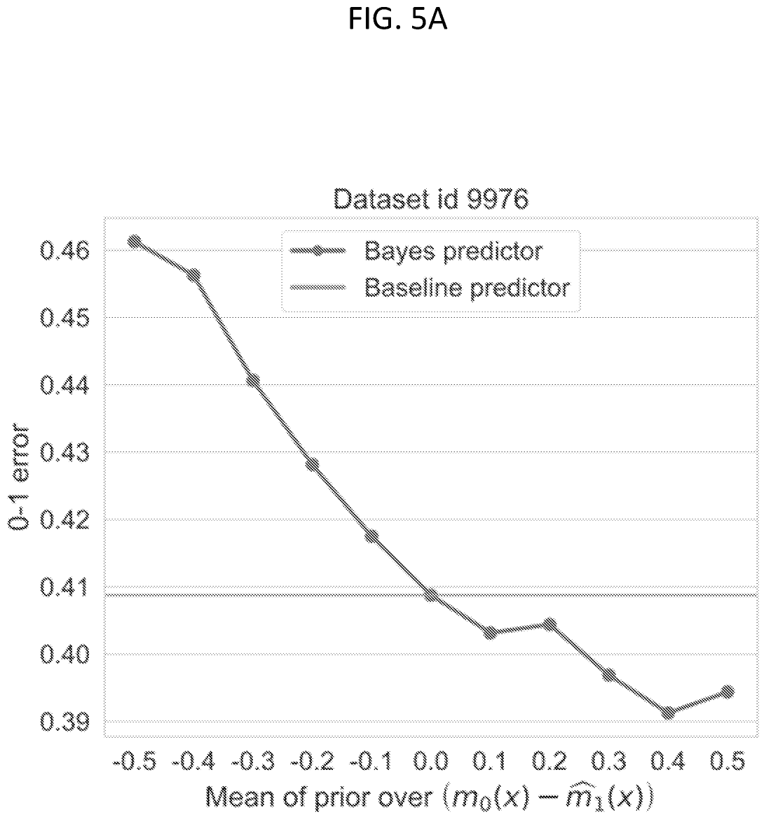

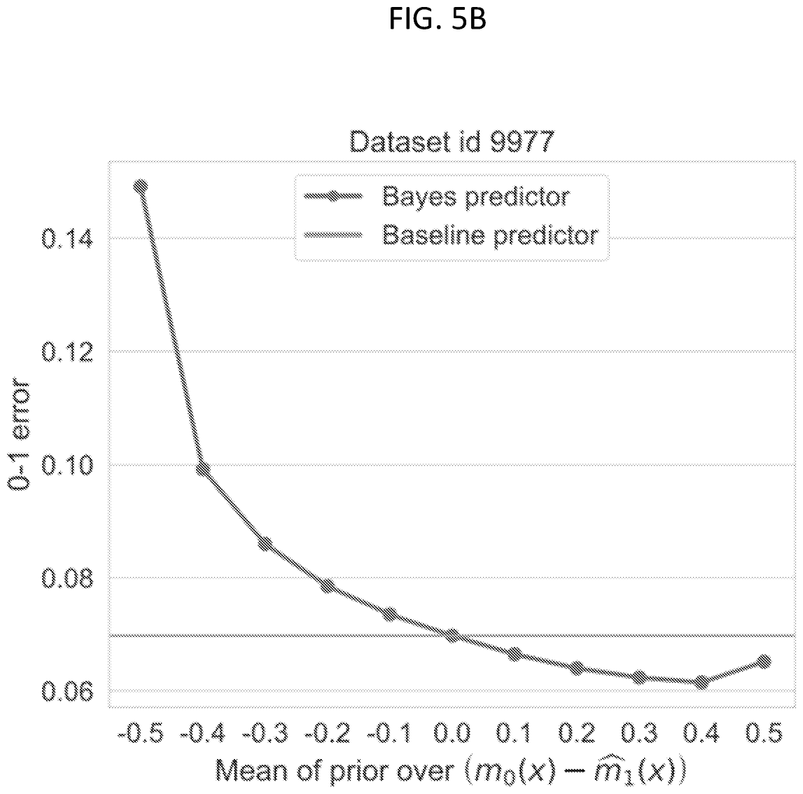

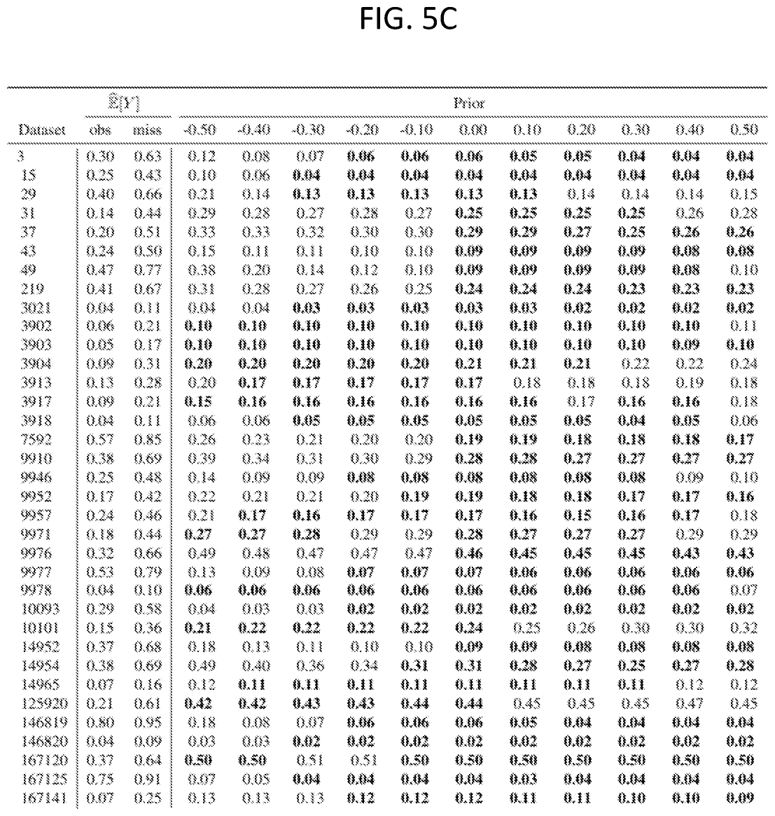

FIGS. 5A-5B illustrate classification error for two binary classification tasks with induced MNAR from a benchmark dataset in accordance with an exemplary embodiment More specifically, FIG. 5A illustrates both a baseline predictor and a Bayes predictor after performing Bayesian regularization for the MNAR in dataset ID 9976 of the OpenML CC-18 benchmark. According to exemplary aspects, the baseline predictor \hat{m}₁(x) trained on the labeled data L is shown as a horizontal line. FIG. 5B illustrates a baseline predictor and the Bayes predictor after performing Bayesian regularization for the MNAR in dataset ID 9977 of the OpenML CC-18 benchmark. FIGS. 5A-5C exemplarily illustrate that even a crude prior applied to MNAR would yield improvement over a baseline predictor or model that ignores or omits MNAR.

According to exemplary aspects, FIGS. 5A-5B illustrate classification errors for two binary classification tasks with induced MNAR. In these figures, the horizontal line represents a baseline predictor m₁(x) trained on the labeled data L. in the FIGS. 5A-5B, each data point represents Bayes-regularized binary predictors:

$$\{ \hat{π} ( x ) {\hat{m}}_{1} ( x ) + ( 1 - \hat{π} ( x ) ) 𝔼 [ {m}_{0} ( x ) ] \geq 0.5 \}$$

The above noted Bayes-regularized binary predictors are for different prior values noted below:

$$𝔼 [ {m}_{0} ( x ) ] = {\hat{m}}_{1} ( x ) + C$$

The models \hat{π}(x), \hat{m}₁(x) may be constructed using xgboost classifiers. According to exemplary aspects, appropriate prior values may reduce error relative to baseline.

Bayesian regularization is exemplarily provided via experimentation data illustrated in FIGS. 5A-5C. The Bayesian regularization examples of FIGS. 5A-5C utilize datasets from Open ML-CC18 benchmark, which includes a set of real-world classification tasks designed for machine learning benchmarking. In this experimentation, the benchmarking was restricted to binary classification tasks.

In order to induce MNAR for the experimentation, datasets are restricted to binary classification, and in each dataset the following setting was specified:

$$P ( D = 1 \vert Y = 0 ) = 0.4 and P ( D = 1 \vert Y = 1 ) = 0.7$$

Then, missingness indicator D was randomly sampled according to the above noted probabilities. Further, a train/test split of 80%/20% is utilized and the train data is split into labeled and unlabeled sets L and U.

The baseline xgboost classifier \hat{m}₁(x) is trained on the labeled data L and the xgboostclassifier \hat{π}(x) is trained on the full training data. In order to define E[m₀(x)], domain experts may know that positive values of Y are more likely to be missing. The prior sets E[m₀(x)] to be a constant value C larger than \hat{m}₁(x), such that:

$$\hat{m} ( x ) = \hat{π} ( x ) {\hat{m}}_{1} ( x ) + {( 1 - \hat{π} ( x ) ) [ ( {\hat{m}}_{1} ( x ) + C ) ]}_{0}^{1}$$

where [·]₀¹ denotes truncation of the argument to lie in [0,1], with the final prediction determined by thresholding \hat{m}₁(x)o·\hat{m}(x) at 0.5. For completeness, 11 values of C in [−0.5, 0.5] are considered.

FIGS. 5A-5B illustrate results for two of the datasets for each prior and the baseline predictor \hat{m}₁(x) (when C=0, the two predictors are equal). In general, positive values of C yield improvements over the baseline, while negative values have the opposite effect Complete results are provided in FIG. 5C. In FIG. 5C, [symbol] [Y] refers to the empirical mean outcome value in the observed versus missing data. The prior represents a quantity C:= [symbol] [m₀(x)]−\hat{m}₁(x) with a prior of 0 returning the baseline predictor \hat{m}₁(x). The prior columns represents 0-1 errors, with bold values indicating values at least as small as the baseline predictor. Both \hat{π}(x) and \hat{m}₁(x) are trained using xgboost classifiers. Positive priors are more likely to result in a reduction in error, which makes sense since MNAR was induced by creating a higher likelihood of missingness for Y=1 versus Y=0. Even such a simple prior often offers improvements over the baseline approach.

When the baseline predictor achieves low error, there may be little room for improvement via regularization (see e.g., FIG. 5B). When the baseline error rate is higher, regularization offers more potential for improvements (see e.g., FIG. 5A).

Note that the actual value of m₀(x) is given by

$$P ( Y = 1 \vert D = 0 , X = x ) = \frac{ℙ ( D = 0 \vert Y = 1 , X = x ) ℙ ( Y = 1 \vert X = x )}{ℙ ( D = 0 \vert X = x )} .$$

Such relationship is not linear in m₁(x), so this type of prior represents a crude form of domain knowledge. However, even such crude prior may yield improvements over baseline in the presence of MNAR.

In operation 404, the unknown components or quantities that were provided with values in operations 402 and 403 via estimation and/or injection, respectively, are reassembled to provide a modified function that accounts for the MNAR in the acquired dataset.

The reassembled function provides values for the unknown quantities present in the originally generated function for processing the MNAR data. Accordingly, the reassembled function may more comprehensively represent data reflective of real-world environment, resulting in a more accurate or representative ML or AI algorithm or model.

According to exemplary aspects, a tractable way to conduct Bayesian regularization of a regression function has been described along with a demonstration of its performance on a range of datasets. As exemplarily illustrated in at least FIGS. 5A-5B, the proposed method improves over existing or conventional baseline on a range of datasets.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for accounting for missing not-at-random (MNAR) data in training datasets by performing Bayesian regularization, the method comprising:
acquiring, by a processor and from at least one database, historical data of an organization, the historical data including the MNAR data, the MNAR data being data where outcomes are MNAR;
performing, by the processor, estimation for two of the at least three unknown quantities based on the historical data;
injecting, by the processor, quantitative information for remaining one of the at least three unknown quantities based on qualitative information regarding nature of missingness; and
reassembling, by the processor, the estimation for two of the at least three unknown quantities and injected quantitative information for the remaining one of the at least three unknown quantities, to provide a modified function.

2. The method according to claim 1, wherein the estimation includes training machine learning models for the two unknown quantities.

3. The method according to claim 1, wherein a Bayes risk minimizer is utilized in the performing of the estimation.

4. The method according to claim 3, wherein the Bayes risk minimizer is a mean squared error (MSE).

5. The method according to claim 1, wherein the Bayesian regularization utilize external information about the function when a missingness indicator is 0 to construct the modified function.

6. The method according to claim 3, wherein the Bayes risk minimizer is 0-1 loss.

7. The method according to claim 1, wherein a value within a reference vicinity of one of the two unknown quantities being estimated when a missingness indicator is 0 is utilized to construct the modified function.

8. The method according to claim 1, wherein the MNAR data is addressed without using an assumption or a restriction about the distribution of missing values.

9. The method according to claim 1, wherein one of the estimation is constructed by regressing an outcome on features in labeled data.

10. The method according to claim 9, wherein other of the estimation is constructed by regressing a missingness indicator on the features in both the labeled data and unlabeled data.

11. The method according to claim 1, wherein the estimation of the two of the at least three unknown quantities is performed by training two separate machine learning models.

12. The method according to claim 11, wherein a first of the two machine learning models is trained based on both labeled data and unlabeled data, and a second of the two machine learning models is trained based on the labeled data only.

13. The method according to claim 1, wherein the reassembling incorporates priors over the MNAR outcomes.

14. The method according to claim 1, wherein the reassembling is performed using a linear combination.

15. The method according to claim 1, wherein the injecting of the quantitative information includes injecting the qualitative information in a form of a prior over E[m₀(x)] at each point x.

16. The method according to claim 1, wherein the quantitative information for remaining one of the at least three unknown quantities is injected by a domain expert.

17. A system for accounting for missing not-at-random (MNAR) data in training dataset by performing Bayesian regularization, the system comprising:
a memory; and
a processor,
wherein the system is configured to perform:
acquiring, from at least one database, historical data of an organization, the historical data including the MNAR data, the MNAR data being data where outcomes are MNAR;
performing estimation for two of the at least three unknown quantities based on the historical data;
injecting quantitative information for remaining one of the at least three unknown quantities based on qualitative information regarding nature of missingness; and
reassembling the estimation for two of the at least three unknown quantities and injected quantitative information for the remaining one of the at least three unknown quantities, to provide a modified function.

18. The system according to claim 17, wherein the estimation includes training machine learning models for the two unknown quantities.

19. The system according to claim 17, wherein the estimation of the two of the at least three unknown quantities is performed by training two separate machine learning models.

20. A non-transitory computer readable storage medium that stores a computer program for accounting for missing not-at-random (MNAR) data in training dataset by performing Bayesian regularization, the computer program, when executed by a processor, causing a system to perform a plurality of processes comprising:
acquiring, from at least one database, historical data of an organization, the historical data including the MNAR data, the MNAR data being data where outcomes are MNAR;
performing estimation for two of the at least three unknown quantities based on the historical data;
injecting quantitative information for remaining one of the at least three unknown quantities based on qualitative information regarding nature of missingness; and
reassembling the estimation for two of the at least three unknown quantities and injected quantitative information for the remaining one of the at least three unknown quantities, to provide a modified function.
